(19) United States
(12) Patent Application Publication
(10) Pub. No.: US 2023/0170676 A1
(43) Pub. Date: Jun. 1, 2023

(54) MOUNTING DEVICE FOR MOUNTING SLEEVE ON COAXIAL CABLE, MOUNTING METHOD FOR MOUNTING SLEEVE ON COAXIAL CABLE AND SHIELDED ELECTRICALLY CONDUCTIVE PATH

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Atsushi MURATA, Mie (JP); Kazuaki HAMADA, Mie (JP); Yusuke KOJIMA, Mie (JP)

(21) Appl. No.: 17/922,902

(22) PCT Filed: Apr. 27, 2021
(86) PCT No.: PCT/JP2021/016698

§ 371 Date: Nov. 2, 2022

(30) Foreign Application Priority Data
May 18, 2020 (JP) 2020-086583

(51) Int. Cl. H02G 1/14; H01R 43/28; H02G 15/02; H01R 24/40

(52) U.S. Cl. CPC H02G 1/14; H01R 43/28; H02G 15/025; H01R 24/40; H01R 2103/00

(57) ABSTRACT

It is aimed to externally fit a sleeve formed into a tubular shape to a braided wire. A mounting device is a device for mounting a tubular sleeve on a coaxial cable having a front end part of a braided wire exposed in front of a sheath to externally fit the sleeve to the braided wire, and is provided with an expansion restricting jig including an expansion restricting portion for restricting expansive deformation of the braided wire and relatively displaceable in an axial direction with respect to the braided wire with the expansion restricting portion held in contact with an outer peripheral surface of the braided wire. The expansion restricting jig is formed with a positioning portion for positioning the sleeve concentrically with the braided wire with the sleeve arranged forward of the expansion restricting portion.

### TECHNICAL FIELD

The present disclosure relates to a mounting device for mounting a sleeve on a coaxial cable, a mounting method for mounting a sleeve on a coaxial cable and a shielded electrically conductive path.

### BACKGROUND

Patent Document 1 discloses a connection structure for connecting a contact means and a coaxial cable. In this connection structure, a sleeve (ferrule) made of metal is externally fit to a braided wire (outer conductor) of the coaxial cable, a front end part of the braided wire is folded rearward and put on the outer periphery of the sleeve, and a crimping part of the contact means is crimped to the outer peripheries of the sleeve and the folded front end part of the braided wire. By externally fitting the sleeve made of metal to the braided wire, it is possible to achieve impedance matching and improve communication performance in a high-speed transmission circuit.

The sleeve is formed of a U-shaped plate material and externally fit to the braided wire by deforming and winding the sleeve on the outer periphery of the braided wire. In a state externally fit to the braided wire, both edge parts of the sleeve in a circumferential direction are butted against each other in the circumferential direction. By this butting, the sleeve is so held that an inner diameter thereof does not become excessively small.

### PRIOR ART DOCUMENT

### Patent Document

Patent Document 1: JP 2017-168440 A

### SUMMARY OF THE INVENTION

### Problems to be Solved

In the structure for winding and mounting the sleeve, there is a concern that the both end edge parts of the sleeve radially overlap without butting against each other and the inner diameter of the sleeve becomes excessively small if a crimping force of the crimping part is strong. If the inner diameter of the sleeve becomes excessively small, there is a concern that an interval in a radial direction between the core wire of the coaxial cable and the braided wire becomes small and impedance matching is lost to cause a reduction in communication performance.

As a method for preventing the inner diameter of the sleeve from becoming excessively small, a sleeve formed into a tubular shape may be externally fit to the braided wire from front of the coaxial cable. However, since the braided wire is formed by braiding a plurality of metal strands into a mesh and the metal strands are cut on the front end of the braided wire, it is unavoidable that the metal strands are deformed to expand on the front end of the braided wire. Thus, it has been difficult to externally fit the sleeve formed into a tubular shape to the braided wire from front.

A mounting device, a mounting method and a shielded electrically conductive path of the present disclosure were completed on the basis of the above situation and aims to externally fit a sleeve formed into a tubular shape to a braided wire.

### Means to Solve the Problem

A first aspect of the present disclosure is directed to a mounting device for mounting a tubular sleeve on a coaxial cable having a front end part of a braided wire exposed in front of a sheath to externally fit the sleeve to the braided wire, the mounting device including an expansion restricting jig having an expansion restricting portion for restricting expansive deformation of the braided wire, the expansion restricting jig being relatively displaceable in an axial direction with respect to the braided wire with the expansion restricting portion held in contact with an outer peripheral surface of the braided wire, the expansion restricting jig being formed with a positioning portion for positioning the sleeve concentrically with the braided wire with the sleeve arranged forward of the expansion restricting portion.

A second aspect of the present disclosure is directed to a mounting method for mounting a tubular sleeve on a coaxial cable having a front end part of a braided wire exposed in front of a sheath to externally fit the sleeve to the braided wire, the mounting method including providing an expansion restricting jig having an expansion restricting portion for restricting expansive deformation of the braided wire and a positioning portion for positioning the sleeve concentrically with the braided wire in front of the expansion restricting portion, externally fitting the expansion restricting portion to a front end part of the braided wire, positioning the sleeve concentrically with the braided wire by the positioning portion, and moving the sleeve to a position for surrounding the braided wire by sliding the expansion restricting jig and the sleeve integrally rearward with the expansion restricting portion held in contact with an outer peripheral surface of the braided wire.

A third aspect of the present disclosure is directed to a shielded electrically conductive path with a coaxial cable having a front end part of a braided wire exposed in front of a sheath, a sleeve formed into a tubular shape, the sleeve being mounted on the coaxial cable to be externally fit to the braided wire, and an outer conductor crimped to the coaxial cable while surrounding the sleeve, a tapered guiding surface inclined to increase an inner diameter toward a rear end being formed on an inner peripheral surface of a rear end part of the sleeve.

### Effect of the Invention

According to the first to third aspects of the present disclosure, it is possible to externally fit a sleeve formed into a tubular shape to a braided wire.

### BRIEF DESCRIPTION OF THE DRAWINGS

FIG. 1 is a side view in section of a shielded electrically conductive path of one embodiment.

FIG. 2 is a side view in section of a sleeve.

FIG. 3 is a side view in section of an expansion restricting jig.

FIG. 4 is a front view of the expansion restricting jig.

FIG. 5 is a side view in section of a positioning jig.

FIG. 6 is a front view of the positioning jig.

FIG. 7 is a side view in section of a spacer jig.

FIG. 8 is a front view of the spacer jig.

FIG. 9 is a side view in section showing a state where the expansion restricting jig is mounted on a coaxial cable.

FIG. 10 is a side view in section showing a state where the expansion of a front end of a braided wire is restricted by the expansion restricting jig.

FIG. 11 is a side view in section showing a state where the sleeve is positioned concentrically with respect to the braided wire.

FIG. 12 is a side view in section showing a state where the sleeve is externally fit to the braided wire.

FIG. 13 is a side view in section showing a state where the expansion restricting jig and the positioning jig are removed from the coaxial cable.

FIG. 14 is a side view in section showing a state where the spacer jig is mounted on the coaxial cable.

FIG. 15 is a side view in section showing a state where the sleeve is surrounded with a folded portion of the braided wire.

FIG. 16 is a side view in section showing a state where a core wire is exposed in front of the braided wire.

### DETAILED DESCRIPTION TO EXECUTE THE INVENTION

### Description of Embodiments of Present Disclosure

First, embodiments of the present disclosure are listed and described.

(1) The mounting device for mounting a sleeve on a coaxial cable according to the first aspect of the present disclosure is a mounting device for mounting a tubular sleeve on a coaxial cable having a front end part of a braided wire exposed in front of a sheath to externally fit the sleeve to the braided wire and is provided with an expansion restricting jig including an expansion restricting portion for restricting expansive deformation of the braided wire, the expansion restricting jig being relatively displaceable in an axial direction with respect to the braided wire with the expansion restricting portion held in contact with an outer peripheral surface of the braided wire, the expansion restricting jig being formed with a positioning portion for positioning the sleeve concentrically with the braided wire with the sleeve arranged forward of the expansion restricting portion. According to the configuration of the first aspect of the present disclosure, in mounting the sleeve on the braided wire, the expansion restricting portion is externally fit to the front end part of the braided wire, the sleeve is positioned concentrically with the braided wire in front of the braided wire, and the expansion restricting jig and the sleeve are slid integrally rearward. Since the front end part of the braided wire is held not to expand, the sleeve moves to a position for surrounding the braided wire without interfering with a front end of the braided wire. According to the first aspect of the present disclosure, the sleeve formed into a tubular shape can be externally fit to the braided wire.

(2) Preferably, in (1), the positioning portion is formed to make a rear end of the sleeve adjacent to a front end of the expansion restricting portion. According to this configuration, in the process of sliding the positioning member and the sleeve rearward, the front end part of the braided wire cannot expand in a gap between the front end of the expansion restricting portion and the rear end of the sleeve. Therefore, a step of externally fitting the sleeve to the braided wire can be smoothly performed.

(3) Preferably, in (1) or (2), the expansion restricting jig is configured by uniting a pair of halved expansion restricting members. According to this configuration, the expansion restricting jig can be easily attached to and removed from the braided wire.

(4) Preferably, in (1) to (3), a positioning jig is provided which holds the sleeve and is fit into the positioning portion.

(5) Preferably, in (4), the positioning jig is configured by uniting a pair of halved positioning members. According to this configuration, an operation of removing the positioning jig from the sleeve can be easily performed after the sleeve is externally fit to the braided wire.

(6) Preferably, in (1) to (5), a spacer jig is provided which holds a rear end of the sleeve at a position separated forward from a front end of the sheath. According to this configuration, when a crimping portion of an outer conductor is crimped to the outer periphery of the sleeve, inward facing locking pieces formed on the crimping portion can be arranged between the rear end of the sleeve and the front end of the sht.

(7) The mounting method for mounting a sleeve on a coaxial cable according to the second aspect of the present disclosure is a mounting method for mounting a tubular sleeve on a coaxial cable having a front end part of a braided wire exposed in front of a sheath to externally fit the sleeve to the braided wire and includes providing an expansion restricting jig having an expansion restricting portion for restricting expansive deformation of the braided wire and a positioning portion for positioning the sleeve concentrically with the braided wire in front of the expansion restricting portion, externally fitting the expansion restricting portion to a front end part of the braided wire, positioning the sleeve concentrically with the braided wire by the positioning portion, and moving the sleeve to a position for surrounding the braided wire by sliding the expansion restricting jig and the sleeve integrally rearward with the expansion restricting portion held in contact with an outer peripheral surface of the braided wire. According to the configuration of the second aspect of the present disclosure, in mounting the sleeve on the braided wire, the sleeve moves to the position for surrounding the braided wire without interfering with a front end of the braided wire since the front end part of the braided wire is held not to expand. According to the second aspect of the present disclosure, the sleeve formed into a tubular shape can be externally fit to the braided wire.

(8) The shielded electrically conductive path according to the third aspect of the present disclosure is provided with a coaxial cable having a front end part of a braided wire exposed in front of a sheath, a sleeve formed into a tubular shape, the sleeve being mounted on the coaxial cable to be externally fit to the braided wire, and an outer conductor crimped to the coaxial cable while surrounding the sleeve, a tapered guiding surface inclined to increase an inner diameter toward a rear end being formed on an inner peripheral surface of a rear end part of the sleeve. According to the third aspect of the present disclosure, in externally fitting the sleeve formed into a tubular shape to the braided wire from front of the braided wire, a front end of the braided wire can be accommodated into the sleeve by the guiding surface even if the front end of the braided wire is expanded. According to the third aspect of the present disclosure, the sleeve formed into a tubular shape can be externally fit to the braided wire.

### Details of Embodiments of Present Disclosure

### Embodiment

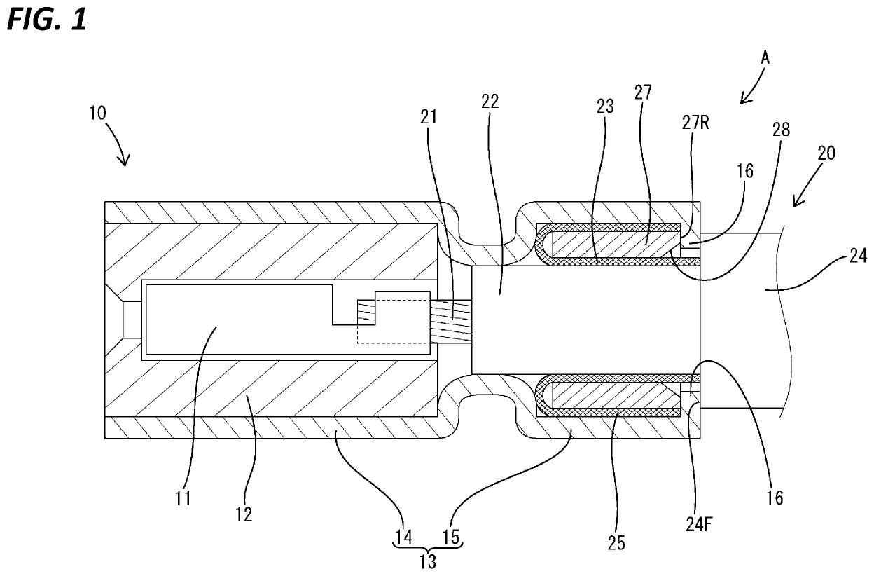

One specific embodiment of the present disclosure is described with reference to FIGS. 1 to 16. Note that the present invention is not limited to these illustrations and is intended to be represented by claims and include all changes in the scope of claims and in the meaning and scope of equivalents. In this embodiment, a left side in FIGS. 1 to 3, 5, 7 and 9 to 16 is defined as a front side concerning a front-rear direction. Upper and lower sides shown in FIGS. 1 to 16 are directly defined as upper and lower sides concerning a vertical direction.

A shielded electrically conductive path A of this embodiment is provided with a shield terminal 10, a coaxial cable 20 and a sleeve 27 as shown in FIG. 1. The shield terminal 10 includes an inner conductor 11, a dielectric 12 accommodating the inner conductor 11 and an outer conductor 13 mounted on the dielectric 12 while surrounding the outer periphery of the dielectric 12. The outer conductor 13 includes a body portion 14 in the form of a rectangular tube constituting a front end part of the outer conductor 13 and a hollow cylindrical crimping portion 15 connected to the rear end of the body portion 14 and constituting a rear end part of the outer conductor 13. The inner conductor 11 and the dielectric 12 are accommodated in the body portion 14.

The crimping portion 15 is a part for fixing the outer conductor 13 to the outer periphery of the coaxial cable 20. The crimping portion 15 has a known shape in the form of an open barrel including a base plate portion extending rearward from the rear end of the body portion 14 and crimping pieces extending in a circumferential direction from side edges of the base plate portion. A plurality of locking pieces 16 projecting radially inward are formed on the rear end edge of the crimping portion 15.

The coaxial cable 20 has such a known form that a coated wire 21 is surrounded with an insulation coating 22, the outer periphery of the insulation coating 22 is surrounded with a tubular braided wire 23 and the outer periphery of the braided wire 23 is surrounded with a sheath 24. In this embodiment, it is assumed that a front end part of the coaxial cable 20 is arranged with an axis oriented in a front-rear direction. In the front end part of the coaxial cable 20, the sheath 24 and the insulation coating 22 are removed to expose the core wire 21 forward of the insulation coating 22 and the sheath 24 is removed to expose the braided wire 23. A front end part of the insulation coating 22 is accommodated in the crimping portion 15 and a front end part of the core wire 21 is conductively fixed to a rear end part of the inner conductor 11.

The sleeve 27 is externally fit to the outer periphery of the braided wire 23 in front of the sheath 24. A front end part of the braided wire 23 serves as a folded portion 25 folded rearward near the front end of the sleeve 27. The folded portion 25 surrounds the entire outer periphery of the sleeve 27. The crimping portion 15 is crimped to the outer periphery of the folded portion 25. A radially inward crimping force by the crimping portion 15 is received by the sleeve 27, and the folded portion 25 is radially sandwiched between the sleeve 27 and the crimping portion 15. The outer conductor 13 having a shielding function and the braided wire 23 having a shielding function are conductively connected in the crimping portion 15.

A gap is secured in the front-rear direction between a rear end 27R of the sleeve 27 and a front end 24F of the sheath 24. The locking pieces 15 of the crimping portion 15 are accommodated in this gap. The locking pieces 16 are arranged to come into contact with or proximately face the rear end 27R of the sleeve 27 from behind. If a rearward pulling force is applied to the coaxial cable 20, the rear end 27R of the sleeve 27 comes into contact with the locking pieces 16. Thus, the coaxial cable 20 is prevented from being relatively displaced rearward with respect to the outer conductor 13.

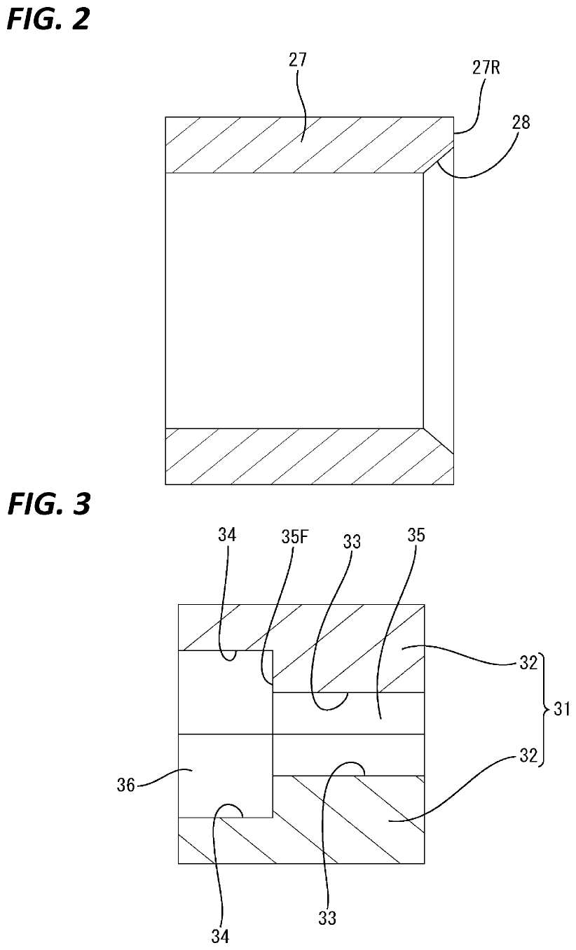

The sleeve 27 is not formed by bending a metal plate material in the form of a flat plate into a circular shape, but is formed into a hollow cylindrical shape continuous over an entire periphery from the start. As shown in FIG. 2, a tapered guiding surface 28 inclined to gradually reduce an inner diameter toward the front is formed on the inner periphery of a rear end part of the sleeve 27. Having no seam where ends butt against each other in the circumferential direction, the sleeve 27 is high in rigidity and can reliably receive the radially inward crimping force applied to the sleeve 27 from the crimping portion 15. Therefore, a radial interval between the core wire 21 and the braided wire 23 is kept constant between a part of the coaxial cable 20 where the crimping portion 15 is crimped and a part thereof where the crimping portion 15 is not crimped. Since impedance matching is possible in this way, the coaxial cable 20 has high communication performance.

Since the braided wire 23 is formed by braiding a plurality of metal strands into a mesh and the metal strands are cut on the front end of the braided wire, cut ends of the metal strands are deformed to warp radially outward in the front end part of the braided wire 23. The sleeve 27 is formed into a seamless hollow cylindrical shape and an inner diameter thereof is equal to or slightly larger than an outer diameter of the braided wire 23. Thus, if an attempt is made to externally fit the sleeve 27 to the braided wire 23 from front of the coaxial cable 20, the metal strands deformed to expand a diameter interfere with the sleeve 27. A mounting device 30 to be described below is used in this embodiment to externally fit the sleeve 27 to the braided wire 23 without interference with the metal strands.

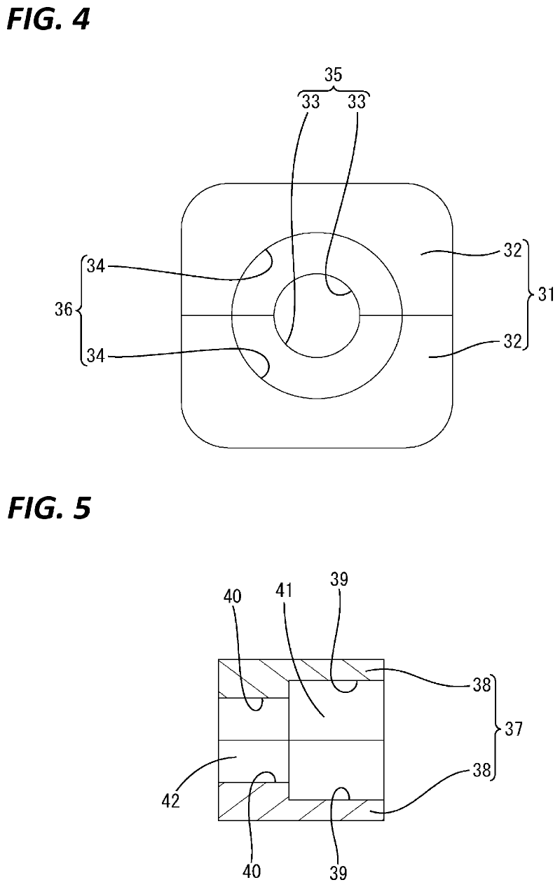

The mounting device 30 uses an expansion restricting jig 31, a positioning jig 37 and a spacer jig 43. As shown in FIGS. 3 and 4, the expansion restricting jig 31 is configured by vertically uniting a pair of vertically symmetrical halved expansion restricting members 32. An expansion restricting recess 33 and a positioning recess 34 are formed in the inner surface of each expansion restricting member 32. A cross-sectional shape obtained by cutting the expansion restricting recess 33 perpendicularly to the front-rear direction (hereinafter, merely referred to as a “cross-sectional shape”) is a semicircular shape. A cross-sectional shape of the positioning recess 34 is a semicircular shape concentric with the expansion restricting recess 33. With the pair of expansion restricting members 32 united, a hole-like expansion restricting portion 35 having a circular cross-section is formed by a pair of the expansion restricting recesses 33 and a hole-like positioning portion 36 having a circular cross-section is formed by a pair of the positioning recesses 34.

The expansion restricting portion 35 is formed in a rear end side region of the expansion restricting jig 31 in the front-rear direction. The rear end of the expansion restricting portion 35 forms a circular opening in the rear end surface of the expansion restricting jig 31. An inner diameter of the expansion restricting portion 35 is constant over the entire length of the expansion restricting portion 35 and equal to the outer diameter of the braided wire 23 and the inner diameter of the sleeve 27. The positioning portion 36 is formed in a front end side region of the expansion restricting jig 31 in the front-rear direction and arranged concentrically with the expansion restricting portion 35. The rear end of the positioning portion 36 and the front end of the expansion restricting portion 35 are adjacent to each other and communicate via a step. The front end of the positioning portion 36 forms a circular opening in the front end surface of the expansion restricting jig 31. An inner diameter of the positioning portion 36 is constant over the entire length of the positioning portion 36 and larger than the inner diameter of the expansion restricting portion 35 and equal to an outer diameter of the positioning jig 37.

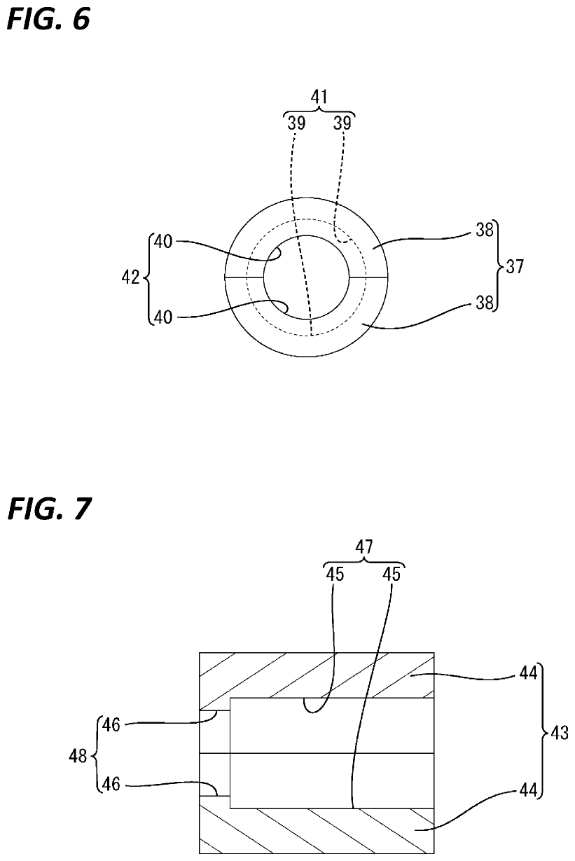

As shown in FIGS. 5 and 6, the positioning jig 37 is configured by vertically uniting a pair of vertically symmetrical halved positioning members 38. A cross-sectional shape of the outer surface of each positioning member 38 is a semicircular shape. With the pair of positioning members 38 united, a cross-sectional shape of the outer peripheral surface of the positioning jig 37 is a circular shape. The outer diameter of the positioning jig 37 is equal to the inner diameter of the positioning portion 36 of the expansion restricting jig 31.

A holding recess 39 and a reduced-diameter recess 40 are formed in the inner surface of each positioning member 38. A cross-sectional shape of the holding recess 39 is a semicircular shape concentric with the outer surface of the positioning jig 37. A cross-sectional shape of the reduced-diameter recess 40 is a semicircular shape concentric with the outer surface of the positioning jig 37 and the holding recess 39. With the pair of positioning members 38 united, a hole-like holding portion 41 is formed by a pair of the holding recesses 39 and a hole-like reduced-diameter portion 42 is formed by a pair of the reduced-diameter recesses 40. Cross-sectional shapes of the holding portion 41 and the reduced-diameter portion 42 are circular shapes concentric with the outer peripheral surface of the positioning jig 37.

The holding portion 41 is formed in a rear end side region of the positioning jig 37 in the front-rear direction. The rear end of the holding portion 41 forms a circular opening in the rear end surface of the positioning jig 37. An inner diameter of the holding portion 41 is constant over the entire length of the holding portion 41 and equal to an outer diameter of the sleeve 27. The reduced-diameter portion 42 is formed in a front end side region of the positioning jig 37 in the front-rear direction and arranged concentrically with the holding portion 41. The rear end of the reduced-diameter portion 42 and the front end of the holding portion 41 are adjacent to each other and communicate via a step. The front end of the reduced-diameter portion 42 forms a circular opening in the front end surface of the positioning jig 37. An inner diameter of the reduced-diameter portion 42 is constant over the entire length of the reduced-diameter portion 42, smaller than the inner diameter of the holding portion 41 and equal to the inner diameter of the expansion restricting portion 35.

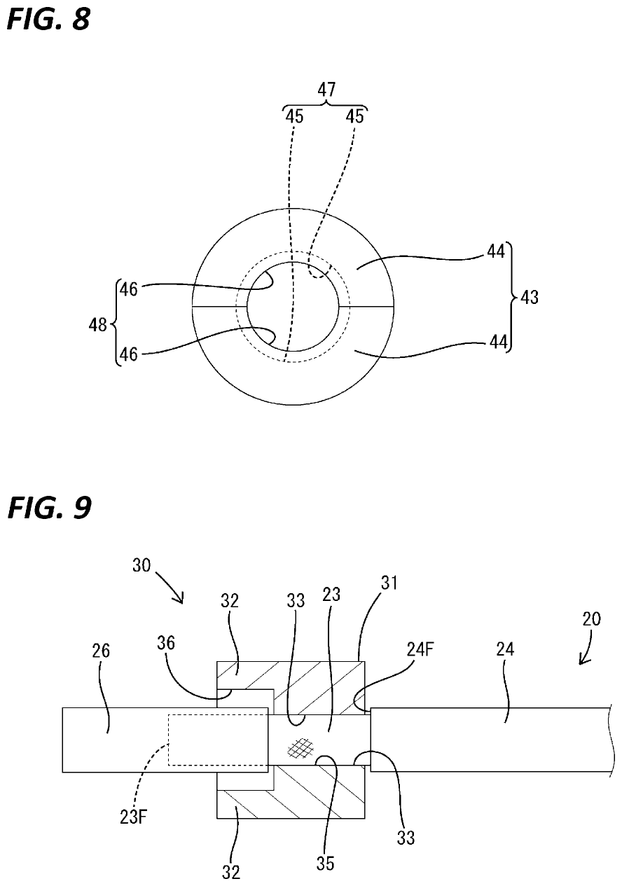

As shown in FIGS. 7 and 8, the spacer jig 43 is configured by vertically uniting a pair of vertically symmetrical halved spacer members 44. A large-diameter recess 45 having a semicircular cross-sectional shape and a small-diameter recess 45 having a semicircular cross-sectional shape concentric with that of the large-diameter recess 45 are formed in the inner surface of each spacer member 44. With the pair of spacer members 44 united, a hole-like large-diameter portion 47 having a circular cross-sectional shape is formed by a pair of the large-diameter recesses and a hole-like small-diameter portion 48 having a circular cross-sectional shape is formed by a pair of the small-diameter recesses 46.

The large-diameter portion 47 is formed in a rear end side region of the spacer jig 43 in the front-rear direction. The rear end of the large-diameter portion 47 forms a circular opening in the rear end surface of the spacer jig 43. An inner diameter of the large-diameter portion 47 is constant over the entire length of the large-diameter portion 47 and equal to an outer diameter of the sheath 24. The small-diameter portion 48 is formed in a front end side region of the spacer jig 43 in the front-rear direction and arranged concentrically with the large-diameter portion 47. The rear end of the small-diameter portion 48 and the front end of the large-diameter portion 47 are adjacent to each other and communicate via a step. The front end of the small-diameter portion 48 forms a circular opening in the front end surface of the spacer jig 43. An inner diameter of the small-diameter portion 48 is constant over the entire length of the small-diameter portion 48, larger than the outer diameter of the braided wire 23 and smaller than the outer diameter of the sheath 24.

Next, a mounting method for mounting the sleeve 27 on the coaxial cable 20 using the mounting device 30 and a preparation procedure for crimping the crimping portion 15 of the outer conductor 13 to the braided wire 23 are described. First, a cut is formed in the circumferential direction in the sheath 24 and a cut piece 26 of the sheath 24 forward of the cut is slid forward as shown in FIG. 9. At this time, the cut piece 26 is held in close contact with the front end part of the braided wire 23 while surrounding the front end part of the braided wire 23, so that a front end 23F of the braided wire 23 is hold not to expand. With the expansion of the braided wire 23 restricted, the expansion restricting recesses 33 are placed between the front end 24F of the sheath 24 and the cut piece 26 and held in close contact with the outer peripheral surface of the braided wire 23 while the pair of expansion restricting members 32 are united.

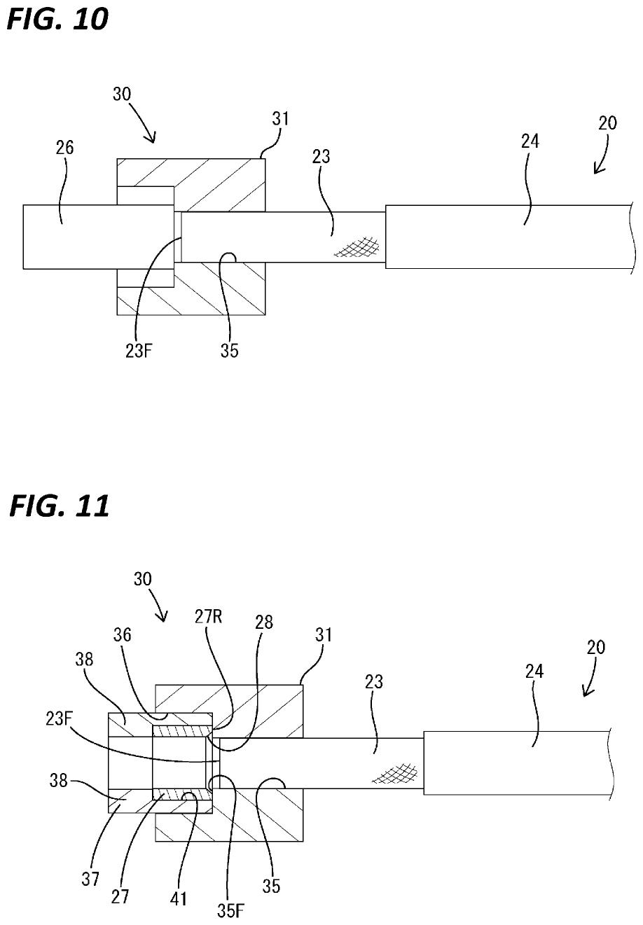

Subsequently, as shown in FIG. 10, the expansion restricting jig 31 and the cut piece 26 are slid forward while the expansion restricting portion 35 is slid in contact with the outer peripheral surface of the braided wire 23. If the expansion restricting jig 31 is slid to a position where the cut piece 26 of the sheath 24 is separated forward from the braided wire 23, a front end part of the expansion restricting portion 35 surrounds the front end 23F of the braided wire 23 while being held in close contact with the front end 23F of the braided wire 23. The front end of the expansion restricting portion 35 is located at the same position or forward of the front end 23F of the braided wire 23 in the front-rear direction. Therefore, the front end 23F of the braided wire 23 is not expansively deformed.

Subsequently, the pair of positioning members 38 are united, the sleeve 27 is fit into the holding portion 41, and the positioning jig 37 and the sleeve 27 are integrated. The integrated positioning jig 37 and sleeve 27 are assembled with the expansion restricting jig 31 from front. As shown in FIG. 11, with the positioning jig 37 and the sleeve 27 assembled with the expansion restricting jig 31, a rear end side part of the positioning jig 37, i.e. a region of the positioning jig 37 where the holding portion 41 for holding the sleeve 27 is formed, is fit into the positioning portion 36. The sleeve 27 and the positioning jig 37 are restricted from being relatively displaced rearward with respect to the expansion restricting jig 31 and positioned with radial relative displacements restricted. That is, the rear end 27R of the sleeve 27 and a front end 35F of the expansion restricting portion 35 are concentrically positioned while being adjacent to each other in the front-rear direction. The rear end 27R of the sleeve 23 is located forward of the front end 23F of the braided wire 23 across a tiny gap (interval from the front end 23F of the braided wire 23 to the front end 35F of the expansion restricting portion 35) in the front-rear direction.

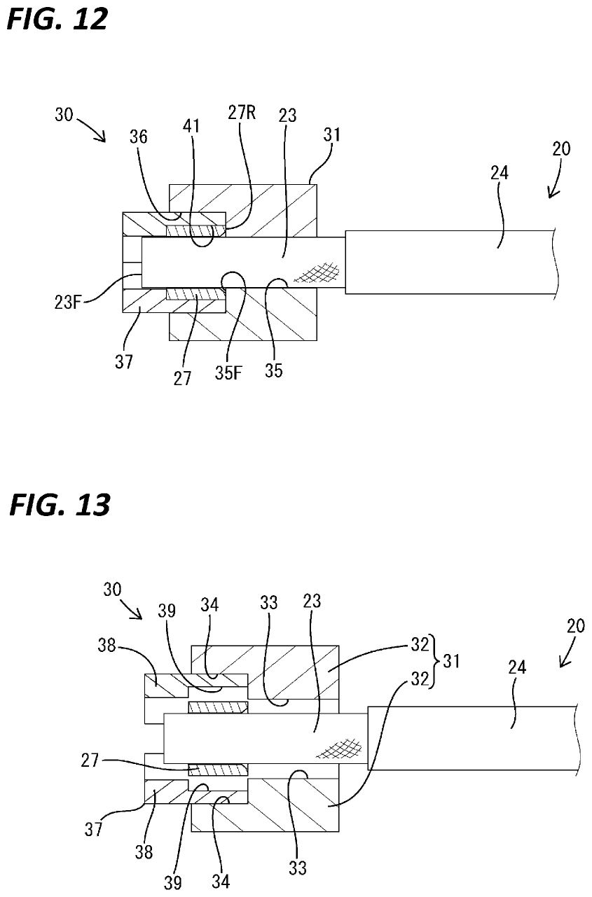

Subsequently, as shown in FIG. 12, the expansion restricting jig 31, the positioning jig 37 and the sleeve 27 are slid integrally rearward, whereby the sleeve 27 is externally fit to the braided wire 23. In the process of moving the rear end 27R of the sleeve 27 to a position for surrounding the front end 23F of the braided wire 23, the rear end 27R of the sleeve 27 is externally fit to the braided wire 23 immediately after the front end 35F of the expansion restricting portion 35 passes through the front end 23F of the braided wire 23. The tapered guiding surface 28 is formed on the inner periphery of the rear end part of the sleeve 27. Even if the front end 23F of the braided wire 23 is slightly expansively deformed, the front end 23F of the braided wire 23 is reduced in diameter and deformed by the guiding surface 28 the moment the front end 35F of the expansion restricting portion 35 passes through the front end 23F of the braided wire 23. Therefore, the sleeve 27 is externally fit to the braided wire 23 without interfering with the front end 23F of the braided wire 23.

After the sleeve 27 is externally fit to the braided wire 23, the expansion restricting jig 31 and the positioning jig 37 are removed from the coaxial cable 20 by being vertically divided as shown in FIG. 13. Even if the expansion restricting jig 31 and the positioning jig 37 are removed from the coaxial cable 20, the sleeve 27 is held externally fit to the braided wire 23. At this time, the entire sleeve 27 may move behind the front end 23F of the braided wire 23 or a front end part of the sleeve 27 may be located forward of the front end 23F of the braided wire 23. In the above way, a step of externally fitting the sleeve 27 to the braided wire 23 is finished.

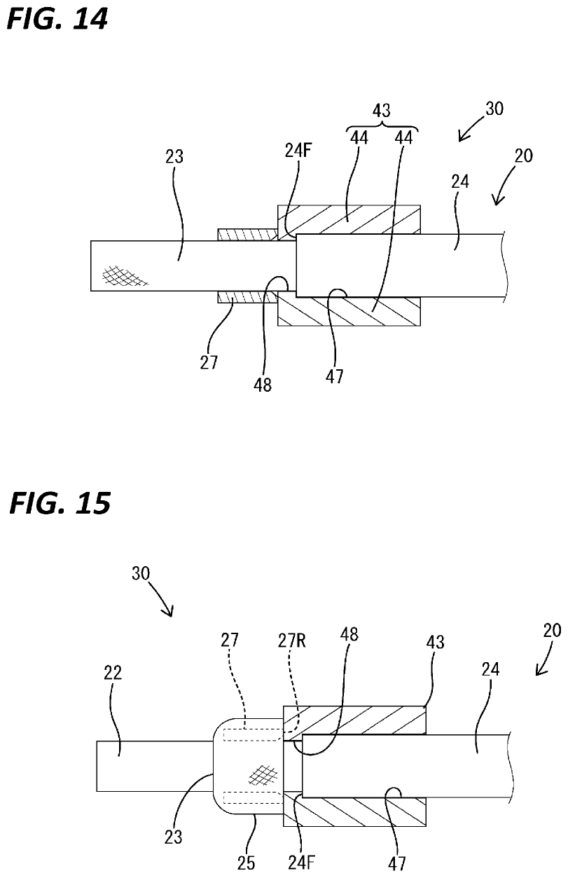

After the expansion restricting jig 31 and the positioning jig 37 are removed from the coaxial cable 20, the pair of spacer members 44 are mounted on the coaxial cable 20 while being united as shown in FIG. 14. At this time, the large-diameter portion 47 is externally fit to a front end part of the sheath 24 and the rear end of the small-diameter portion 48 is brought into contact with the front end 24F of the sheath 24. Subsequently, as shown in FIG. 15, a region of the braided wire 23 forward of the sleeve 27 is folded rearward and put on the outer periphery of the sleeve 27. A part of the braided wire 23 put on the sleeve 27 serves as the folded portion 25, to which the crimping portion 15 of the outer conductor 13 is crimped.

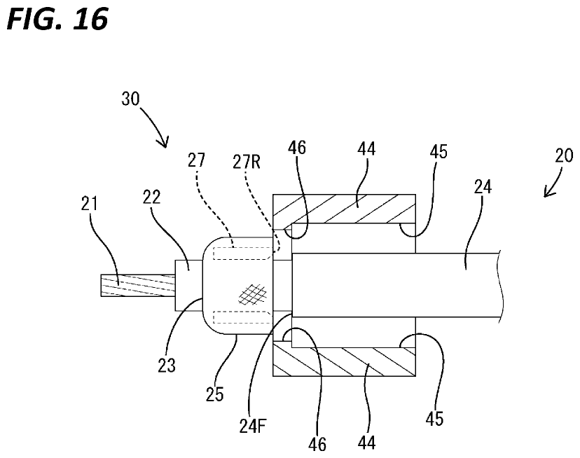

Subsequently, as shown in FIG. 16, a front end part of the insulation coating 22 is removed in front of the braided wire 23 to expose a front end part of the core wire 21 so that the front end part of the core wire 21 is connectable to the inner conductor 11. In the above way, the mounting of the sleeve 27 on the coaxial cable 20 is completed. Thereafter, the front end part of the coaxial cable 20 is assembled with the shield terminal 10, the core wire 21 is fixed to the inner conductor 11 and the crimping portion 15 of the outer conductor 13 is crimped to the folded portion 25 of the braided wire 23.

The mounting device 30 of this embodiment is a device for mounting the tubular sleeve 27 on the coaxial cable 20 having the front end part of the braided wire 23 exposed in front of the sheath 24 to externally fit the sleeve 27 to the braided wire 23. The mounting device 30 includes the expansion restricting jig 31. The expansion restricting jig 31 includes the expansion restricting portion 35 for restricting the expansive deformation of the braided wire 23. The expansion restricting jig 31 can be relatively displaced in an axial direction (front-rear direction) with respect to the braided wire 23 with the expansion restricting portion 35 held in contact with the outer peripheral surface of the braided wire 23. The expansion restricting jig 31 is formed with the positioning portion 36 for positioning the sleeve 27 concentrically with the braided wire 23 with the sleeve 27 arranged forward of the expansion restricting portion 35.

In mounting the sleeve 27 on the braided wire 23, the expansion restricting portion 35 is externally fit to the front end part of the braided wire 23, the sleeve 27 is positioned concentrically with the braided wire 23 in front of the braided wire 23, and the expansion restricting jig 31 and the sleeve 27 are integrally slid rearward. Since the front end part of the braided wire 23 is held not to expand by the expansion restricting portion 35, the sleeve 27 moves to the position for surrounding the braided wire 23 without interfering with the front end 23F of the braided wire 23. Therefore, according to the mounting device 30 of this embodiment, the sleeve 27 formed into a tubular shape can be externally fit to the braided wire 23.

The positioning portion 36 is formed to make the rear end 27R of the sleeve 27 adjacent to the front end 35F of the expansion restricting portion 35. In the process of sliding the positioning members 38 and the sleeve 27 rearward, the front end part of the braided wire 23 is not expanded in the gap between the front end 35F of the expansion restricting portion 35 and the rear end 27R of the sleeve 27. Thus, the step of externally fitting the sleeve 27 to the braided wire 23 can be smoothly performed. Since the expansion restricting jig 31 is configured by vertically uniting the pair of halved expansion restricting members 32, the expansion restricting jig 31 can be easily attached to and removed from the braided wire 23.

The mounting device 30 is provided with the positioning jig 37 configured to hold the sleeve 27 and to be fit into the positioning portion 36. The positioning jig 37 is configured by vertically uniting the pair of halved positioning members 38. After the sleeve 27 is externally fit to the braided wire 23, the positioning jig 37 can be easily removed from the sleeve 27. The mounting device 30 includes the spacer jig 43 for holding the rear end 27R of the sleeve 27 at a position separated forward of the front end 24F of the sheath 24. According to this configuration, when the crimping portion 15 of the outer conductor 13 is crimped to the outer periphery of the sleeve 27, the inward facing locking pieces 16 formed on the crimping portion 15 can be arranged between the rear end 27R of the sleeve 27 and the front end 24F of the sheath 24.

The shielded electrically conductive path A of this embodiment is provided with the coaxial cable 20, the sleeve 27 and the outer conductor 13. In the coaxial cable 20, the front end part of the braided wire 23 is exposed in front of the sheath 24. The sleeve 27 is formed into a tubular shape and mounted on the coaxial cable 20 to be externally fit to the braided wire 23. The outer conductor 13 is crimped to the coaxial cable 20 while surrounding the sleeve 27.

The tapered guiding surface 28 inclined to increase an inner diameter toward the rear end is formed on the inner peripheral surface of the rear end part of the sleeve 27. Even if the front end 23F of the braided wire 23 is expanded, the tapered guiding surface 28 surrounds the front end 23F of the braided wire 23 when the sleeve 27 formed into a tubular shape is externally fit to the braided wire 23 from front of the braided wire 23. Thus, the front end 23F of the braided wire 23 can be accommodated in the sleeve 27. Therefore, in the shielded electrically conductive path A of this embodiment, the sleeve 27 formed into a tubular shape can be externally fit to the braided wire 23.

### OTHER EMBODIMENTS

The present invention is not limited by the above described and illustrated embodiment, but is represented by claims. The present invention is intended to include all changes in the scope of claims and in the meaning and scope of equivalents and also include the following embodiments.

Although the positioning portion makes the rear end of the sleeve adjacent to the front end of the expansion restricting portion in the above embodiment, a tiny gap may be present between the rear end of the sleeve and the front end of the expansion restricting portion with the sleeve positioned in the positioning portion.

Although the expansion restricting jig is configured by uniting the pair of halved expansion restricting members in the above embodiment, the expansion restricting jig may be formed by uniting three or more divided expansion restricting members.

Although the sleeve is positioned in the positioning portion via the positioning jig in the above embodiment, the positioning jig may not be provided and the positioning portion of the expansion restricting jig may position the sleeve by being directly held in contact with the sleeve.

Although the positioning jig is configured by uniting the pair of halved positioning members in the above embodiment, the positioning jig may be formed by uniting three or more divided positioning members.

Although the mounting device is provided with the spacer jig in the above embodiment, the mounting device may not be provided with the spacer jig.

### LIST OF REFERENCE NUMERALS

A shielded electrically conductive path
10 . . . shield terminal
11 . . . inner conductor
12 . . . dielectric
13 . . . outer conductor
14 . . . body portion
15 . . . crimping portion
16 . . . locking piece
20 . . . coaxial cable
21 . . . core wire
22 . . . insulation coating
23 . . . braided wire
23F . . . front end of braided wire
24 . . . sheath
24F . . . front end of the sheath
25 . . . folded portion
26 . . . cut piece
27 . . . sleeve
27 . . . R rear end of sleeve
28 . . . guiding surface
30 . . . mounting device
31 . . . expansion restricting jig
32 . . . expansion restricting member
33 . . . expansion restricting recess
34 . . . positioning recess
35 . . . expansion restricting portion
35 . . . F front end of expansion restricting portion
36 . . . positioning portion
37 . . . positioning jig
38 . . . positioning member
39 . . . holding recess
40 . . . reduced-diameter recess
41 . . . holding portion
42 . . . reduced-diameter portion
43 . . . spacer jig
44 . . . spacer member
45 . . . large-diameter recess
46 . . . small-diameter recess
47 . . . large-diameter portion
48 . . . small-diameter portion

1. A mounting device for mounting a tubular sleeve on a coaxial cable having a front end part of a braided wire exposed in front of a sheath to externally fit the sleeve to the braided wire, comprising:
an expansion restricting jig including an expansion restricting portion for restricting expansive deformation of the braided wire, the expansion restricting jig being relatively displaceable in an axial direction with respect to the braided wire with the expansion restricting portion held in contact with an outer peripheral surface of the braided wire,
the expansion restricting jig being formed with a positioning portion for positioning the sleeve concentrically with the braided wire with the sleeve arranged forward of the expansion restricting portion.

2. The mounting device of claim 1, wherein the positioning portion is formed to make a rear end of the sleeve adjacent to a front end of the expansion restricting portion.

3. The mounting device of claim 1, wherein the expansion restricting jig is configured by uniting a pair of halved expansion restricting members.

4. The mounting device of claim 1, comprising a positioning jig for holding the sleeve, the positioning jig being fit into the positioning portion.

5. The mounting device of claim 4, wherein the positioning jig is configured by uniting a pair of halved positioning members.

6. The mounting device of claim 1, comprising a spacer jig for holding a rear end of the sleeve at a position separated forward from a front end of the sheath.

7. A mounting method for mounting a tubular sleeve on a coaxial cable having a front end part of a braided wire exposed in front of a sheath to externally fit the sleeve to the braided wire, comprising:
providing an expansion restricting jig including an expansion restricting portion for restricting expansive deformation of the braided wire and a positioning portion for positioning the sleeve concentrically with the braided wire in front of the expansion restricting portion,
externally fitting the expansion restricting portion to a front end part of the braided wire;
positioning the sleeve concentrically with the braided wire by the positioning portion; and
moving the sleeve to a position for surrounding the braided wire by sliding the expansion restricting jig and the sleeve integrally rearward with the expansion restricting portion held in contact with an outer peripheral surface of the braided wire.

8. A shielded electrically conductive path, comprising:
a coaxial cable having a front end part of a braided wire exposed in front of a sheath;
a sleeve formed into a tubular shape, the sleeve being mounted on the coaxial cable to be externally fit to the braided wire; and
an outer conductor crimped to the coaxial cable while surrounding the sleeve,
a tapered guiding surface inclined to increase an inner diameter toward a rear end being formed on an inner peripheral surface of a rear end part of the sleeve.
